(19) United States
(12) Patent Application Publication
(10) Pub. No.: US 2026/0091991 A1
(43) Pub. Date: Apr. 2, 2026

(54) EXTRACTION OF CARBON DIOXIDE FROM WATER

(71) Applicant: Massachusetts Institute of Technology, Cambridge, MA (US)

(72) Inventors: Trevor Alan Hatton, Sudbury, MA (US); Xinru Wang, Berkeley, CA (US); Seoni Kim, Cambridge, MA (US); Kyle M. Diederichsen, Cambridge, MA (US); Kripa K. Varanasi, Lexington, MA (US); Michael P. Nitzsche, Plainfield, NJ (US)

(73) Assignee: Massachusetts Institute of Technology, Cambridge, MA (US)

(21) Appl. No.: 19/112,805

(22) PCT Filed: Jul. 21, 2023
(86) PCT No.: PCT/US2023/070751

§ 371 Date: Mar. 18, 2025

Related U.S. Application Data
(60) Provisional application No. 63/376,448, filed on Sep. 21, 2022.

(51) Int. Cl. C02F 1/20; B01D 19/00; B01D 69/08; B01D 71/26; B01D 71/36; C01B 32/50; C02F 1/44; C02F 1/66; C02F 101/10; C02F 103/08

(52) U.S. Cl. CPC C02F 1/20; B01D 19/0005; B01D 19/0031; B01D 69/08; B01D 71/262; B01D 71/36; C01B 32/50; C02F 1/44; C02F 1/66; C02F 2101/10; C02F 2103/08

(57) ABSTRACT

Systems and methods related to the extraction of carbon dioxide (CO₂) from water are generally described.

### RELATED APPLICATIONS

This application claims priority under 35 U.S.C. § 119(e) to U.S. Provisional Patent Application No. 63/376,448, filed Sep. 21, 2022, and entitled “Extractive Desorption of Molecular CO₂ From Sub-Saturated Aqueous Solutions,” which is incorporated herein by reference in its entirety for all purposes.

### GOVERNMENT SPONSORSHIP

This invention was made with Government support under DE-AR0001409 awarded by the U.S. Department of Energy. The Government has certain rights in the invention.

### TECHNICAL FIELD

Systems and methods related to the extraction of carbon dioxide (CO₂) from water are generally described.

### BACKGROUND

Conventional processes for the extraction of CO₂ from seawater generally rely on the protonation of the water feed stream to convert dissolved inorganic carbons (DICs) to molecularly soluble CO₂ or carbonic acid. Since the fugacity (or partial pressure) of CO₂ in the acidified seawater is low, conventional processes utilize a vacuum to desorb CO₂ as a pure stream suitable for pressurization for either geologic storage or utilization. To avoid the simultaneous desorption of naturally dissolved dioxygen (O₂) and dinitrogen (N₂), the seawater can be degassed by a vacuum prior to protonation of the water feed water stream, incurring significant capital costs and energy penalties.

Accordingly, improved systems and methods for the removal of CO₂ from water are needed.

### SUMMARY

The present disclosure is related to systems and methods for the extraction of CO₂ from water. The subject matter of the present invention involves, in some cases, interrelated products, alternative solutions to a particular problem, and/or a plurality of different uses of one or more systems and/or articles.

According to certain embodiments, a system for removing CO₂ from water is described. In some embodiments, the system comprises a water treatment unit configured to adjust pH of the water comprising one or more carbon-containing species from a first pH level to a second pH level that is lower than the first pH level to convert at least some of the one or more carbon-containing species to CO₂. In certain embodiments, the system comprises a CO₂-extraction unit comprising a CO₂-permeable membrane, wherein the CO₂-extraction unit is configured to comprise a CO₂-extraction solution, and wherein the CO₂-extraction unit is configured to remove the CO₂ from the water across the CO₂-permeable membrane into the CO₂-extraction solution. In some embodiments, the system comprises a water regeneration unit configured to adjust the pH of the water from the second pH level to the first pH level.

According to some embodiments, a system for removing CO₂ from water comprises a CO₂-extraction unit comprising a CO₂-permeable membrane, wherein the CO₂-extraction unit is configured to comprise a CO₂-extraction solution comprising a CO₂-extractor, and wherein the CO₂-extraction unit is configured to remove the CO₂ from the water across the CO₂-permeable membrane into the CO₂-extraction solution to produce a CO₂-complexed CO₂-extractor. In certain embodiments, the system comprises an electrochemical cell fluidically connected to the CO₂-extraction unit, wherein the electrochemical cell comprises an anode chamber and a cathode chamber, wherein an outlet of the CO₂-extraction unit is fluidically connected to an inlet of the anode chamber such that the system is configured to: (i) flow the CO₂-extraction solution comprising the CO₂-complexed CO₂-extractor from the CO₂-extraction unit to the anode chamber; and (ii) oxidize at least a portion of the CO₂-extraction solution in the anode chamber to release CO₂ from the CO₂-complexed CO₂-extractor.

In certain embodiments, a method for removing CO₂ from water is described. In some embodiments, the method comprises adjusting pH of the water comprising one or more carbon-containing species from a first pH level to a second pH level that is lower than the first pH level to convert at least some of the one or more carbon-containing species to the CO₂. In certain embodiments, the method comprises exposing the water comprising the CO₂ to a CO₂-extraction unit comprising a CO₂-permeable membrane. In some embodiments, the method comprises exposing a CO₂-extraction solution to the CO₂-extraction unit. In certain embodiments, the method comprises removing the CO₂ from the water across the CO₂-permeable membrane into the CO₂-extraction solution. In some embodiments, the method comprises adjusting the pH of the water from the second pH level to the first pH level.

According to some embodiments, a method for removing CO₂ from water comprises exposing the water comprising the CO₂ to a CO₂-extraction unit comprising a CO₂-permeable membrane. In certain embodiments, the method comprises exposing a CO₂-extraction solution comprising a CO₂-extractor to the CO₂-extraction unit comprising the CO₂-permeable membrane. In some embodiments, the method comprises removing the CO₂ from the water across the CO₂-permeable membrane into the CO₂-extraction solution to produce a CO₂-complexed CO₂-extractor. In certain embodiments, the method comprises flowing the CO₂-extraction solution comprising the CO₂-complexed CO₂-extractor from an outlet of the CO₂-extraction unit to an inlet of an anode chamber of an electrochemical cell. In some embodiments, the method comprises oxidizing at least a portion of the CO₂-extraction solution in the anode chamber to release CO₂ from the CO₂-complexed CO₂-extractor.

According to certain embodiments, a system for removing CO₂ from water comprises a CO₂-extraction unit comprising a CO₂-permeable membrane configured to remove the CO₂ from the water, wherein the water comprises the CO₂ at a partial pressure of greater than or equal to 0.01 bar and at least one gas other than CO₂ at a partial pressure of greater than or equal to 0.01 bar.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a schematic diagram of a system for removing CO₂ from water, in accordance with certain embodiments.

FIG. 2 shows a schematic diagram of an electrochemical system for removing CO₂ from water, in accordance with certain embodiments.

FIG. 3A shows, according to certain embodiments, a schematic diagram of a conventional system for removing CO₂ from seawater.

FIG. 3B shows, according to certain embodiments, a schematic diagram of a system for removing CO₂ from seawater.

FIG. 4A shows, according to certain embodiments, organic redox systems for removing CO₂ from water.

FIG. 4B shows, according to certain embodiments, an electrochemically mediated amine regeneration (EMAR) system for removing CO₂ from water.

FIG. 4C shows, according to certain embodiments, a pH swing system for removing CO₂ from water.

FIG. 4D shows, according to certain embodiments, a bipolar membrane electrodialysis system for removing CO₂ from water.

FIG. 5A shows, according to certain embodiments, a schematic diagram of removing CO₂ from acidified seawater across a membrane into an extractant.

FIG. 5B shows, according to certain embodiments, a schematic diagram of using a membrane contactor for CO₂ extraction.

FIG. 5C shows, according to certain embodiments, distilled water (left) and an aqueous solution of a quinone (right) after passing through a membrane contactor.

FIG. 6 shows, according to certain embodiments, a cyclic voltammogram (CV) of anthraquinone-2,7-disulfonic acid.

FIG. 7A shows, according to certain embodiments, a schematic diagram of a CO₂ extraction system using a quinone, wherein CO₂ is extracted from a water phase by the electrochemical reduction of the quinone.

FIG. 7B shows, according to certain embodiments, a schematic diagram of the CO₂ extraction system using the quinone shown in FIG. 7A, wherein CO₂ is desorbed from the quinone by electrochemical oxidation.

FIG. 8 shows, according to certain embodiments, the CO₂ concentration at an outlet of a quinone reservoir in the CO₂ extraction system shown in FIGS. 7A-7B as a function of time.

FIG. 9A shows, according to certain embodiments, a schematic diagram of an ocean capture system combined with a quinone-based CO₂ extraction system, wherein CO₂ is extracted from a water phase by the electrochemical reduction of the quinone.

FIG. 9B shows, according to certain embodiments, a schematic diagram of the ocean capture system combined with the quinone-based CO₂ extraction system shown in FIG. 9A, wherein CO₂ is desorbed from the quinone by electrochemical oxidation.

FIG. 10 shows, according to certain embodiments, the volumetric gas flow rate from the ocean capture system combined with the quinone-based CO₂ extraction system shown in FIGS. 9A-9B as a function of time.

FIG. 11 shows, according to certain embodiments, a schematic diagram of an extractant mediated direct ocean capture (DOC) system.

FIG. 12A shows, according to certain embodiments, a schematic diagram of a schematic diagram of a conventional system for removing CO₂ from water that utilizes a single stage degassing system.

FIG. 12B shows, according to certain embodiments, the CO₂-extraction effectiveness of the system shown in FIG. 12A.

FIG. 13A shows, according to certain embodiments, a schematic diagram of a schematic diagram of a conventional system for removing CO₂ from water that utilizes a double stage degassing system.

FIG. 13B shows, according to certain embodiments, the CO₂-extraction effectiveness of the system shown in FIG. 13A.

### DETAILED DESCRIPTION

Systems and methods related to the extraction of CO₂ from water are generally described. According to certain embodiments, the system comprises a CO₂-extraction unit comprising a CO₂-permeable membrane. The CO₂-permeable membrane may separate a water flow chamber of the CO₂-extraction unit (e.g., configured to flow the water) from a CO₂-extraction solution flow chamber of the CO₂-extraction unit (e.g., configured to flow a CO₂-extraction solution comprising a CO₂-extractor) such that dissolved CO₂ in the water permeates through the CO₂-permeable membrane and complexes with the CO₂-extractor in the CO₂-extraction solution. The CO₂-extractor advantageously has a comparatively high affinity for CO₂ as compared to other gases that may be dissolved in the water (e.g., N₂ and/or O₂), resulting in a CO₂-extraction system that complexes CO₂ even under low partial pressures of CO₂. The CO₂-permeable membrane may be configured to prevent contamination of the CO₂-extraction solution by the water and/or loss of the CO₂-extraction solution to the water. In some embodiments, for example, the CO₂-permeable membrane may comprise a plurality of pores comprising air (e.g., air plastron) that prevent the water and the CO₂-extraction solution in the CO₂-extraction unit from mixing.

After the CO₂-extractor complexes the CO₂ to form a CO₂-complexed CO₂-extractor, the CO₂-extraction solution may flow to a CO₂-extraction solution regeneration unit to: (i) release CO₂ from the CO₂-complexed CO₂-extractor; and (ii) regenerate the CO₂-extractor. In certain embodiments, for example, the CO₂-extraction solution regeneration unit comprises an electrochemical cell, and the CO₂-extraction solution may be oxidized in an anode chamber of the electrochemical cell to release CO₂ from the CO₂-complexed CO₂-extractor. The CO₂-extraction solution comprising the CO₂ released from the CO₂-extractor may then flow to a flash tank to remove CO₂ from the CO₂-extraction solution. After removing CO₂ in the flash tank, the CO₂-extraction solution may flow to a cathode chamber of the electrochemical cell to reduce the CO₂-extraction solution and regenerate the CO₂-extractant. After regenerating the CO₂-extractant, the CO₂-extraction solution may flow to the CO₂-extraction unit to extract more CO₂ from water.

In certain aspects, the systems described herein advantageously do not comprise a degasification unit and/or a vacuum configured to remove one or more gases from the water, which is in contrast with conventional systems for removing CO₂ from water. In conventional systems, for example, CO₂ is removed from the water via vacuum, and the water is degassed prior to removing the CO₂ to avoid desorption of other naturally dissolved gases (O₂ and N₂) in the water. Furthermore, the CO₂ removed in conventional systems via vacuum has a low partial pressure (e.g., 0.01-0.08 bar), and a multistage compression process is used to raise the pressure of the CO₂ for industry uses. Alternatively, the CO₂ removed from the water in the systems described herein has a comparatively higher partial pressure, therefore significantly reducing energy demands and the overall process footprint as compared to conventional systems.

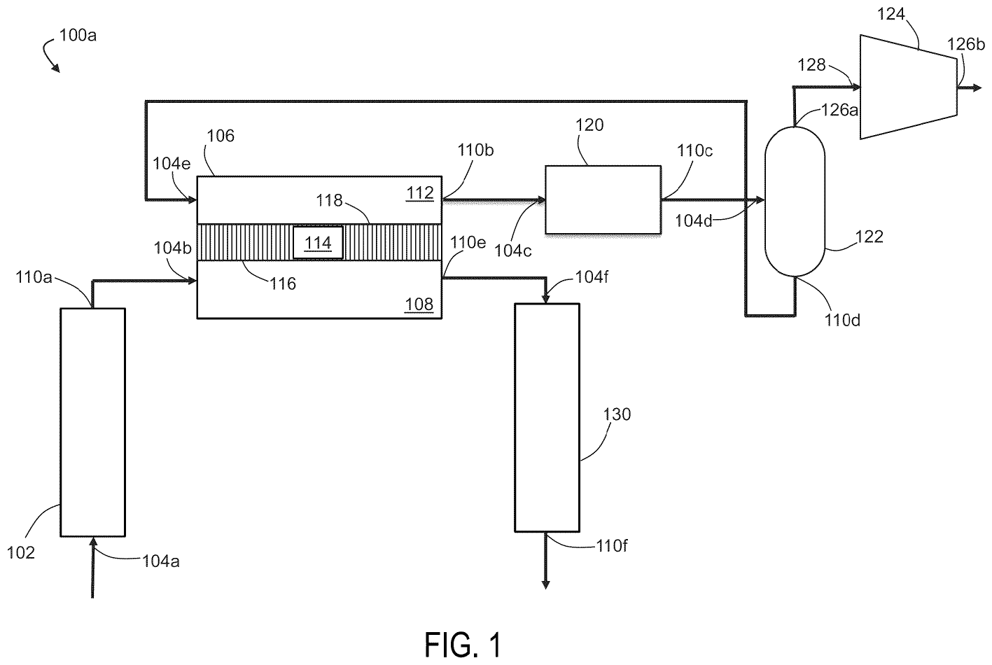

According to certain embodiments, the system comprises a water treatment unit for acidification of water (e.g., a water acidification unit). FIG. 1 shows a schematic diagram of system 100a for removing CO₂ from water, in accordance with certain embodiments. As shown in FIG. 1, system 100a comprises water treatment unit 102.

In certain embodiments, an inlet of the water treatment unit is fluidically connected a water source such that water flowing from the water source flows into the water treatment unit. Referring to FIG. 1, for example, inlet 104a of water treatment unit 102 may be fluidically connected to a water source (not shown in FIG. 1).

Any of a variety of suitable water sources may be envisioned, including, but not limited to, a sea, an ocean, a river, a stream, a lake, a pond, a reservoir, a spring, ground water, and the like.

The water used in the system may be water from any of the water sources described herein. In some embodiments for example, the water used in the system is seawater, ocean water, river water, stream water, lake water, pond water, reservoir water, spring water, ground water, and the like. In certain embodiments, the water used in the system is wastewater (e.g., from a wastewater stream).

In certain embodiments, the water from the water source, prior to flowing through the water treatment unit, may comprise CO₂ (e.g., dissolved CO₂). The water from the water source may comprise CO₂ at any of a variety of suitable pressures (e.g., partial pressures) prior to flowing through the water treatment unit. In some embodiments, for example, the water from the water source comprises CO₂ at a pressure (e.g., partial pressure) of greater than or equal to 0.01 bar, greater than or equal to 0.02 bar, greater than or equal to 0.03 bar, greater than or equal to 0.04 bar, greater than or equal to 0.05 bar, greater than or equal to 0.06 bar, greater than or equal to 0.07 bar, greater than or equal to 0.08 bar, greater than or equal to 0.09 bar, greater than or equal to 0.1 bar, or greater than or equal to 0.5 bar prior to flowing through the water treatment unit. In certain embodiments, the water from the water source comprises CO₂ at a pressure (e.g., partial pressure) of less than or equal to 1 bar, less than or equal to 0.5 bar, less than or equal to 0.1 bar, less than or equal to 0.09 bar, less than or equal to 0.08 bar, less than or equal to 0.07 bar, less than or equal to 0.06 bar, less than or equal to 0.05 bar, less than or equal to 0.04 bar, less than or equal to 0.03 bar, or less than or equal to 0.02 bar prior to flowing through the water treatment unit. Combinations of the above recited ranges are possible (e.g., the water from the water source may comprise CO₂ at a pressure (e.g., partial pressure) of greater than or equal to 0.01 bar and less than or equal to 1 bar prior to flowing through the water treatment unit, the water from the water source may comprise CO₂ at a pressure (e.g., partial pressure) of greater than or equal to 0.04 bar and less than or equal to 0.06 bar prior to flowing through the water treatment unit). Other ranges are also possible.

In certain embodiments, the water from the water source comprises no or substantially no CO₂ (e.g., dissolved CO₂) prior to flowing through the water treatment unit.

The water from the water source, prior to flowing through the water treatment unit, may comprise one or more gases (e.g., one or more dissolved gases) other than CO₂, in some embodiments. For example, in certain embodiments, the water in the water source comprises O₂, N₂, and/or combinations thereof prior to flowing through the water treatment unit. In some embodiments, the water comprises one or more volatile organic gases, such as carbon monoxide (CO) and/or methane (CH₄). Other gases are also possible.

The water from the water source may comprise the one or more gases other than CO₂ (e.g., O₂ and/or N₂) at any of a variety of suitable pressures (e.g., partial pressures) prior to flowing through the water treatment unit. In certain embodiments, for example, the water from the water source comprises the one or more gases other than CO₂ at a pressure (e.g., partial pressure) of greater than or equal to 0.01 bar, greater than or equal to 0.1 bar, greater than or equal to 0.2 bar, greater than or equal to 0.3 bar, greater than or equal to 0.4 bar, greater than or equal to 0.5 bar, greater than or equal to 0.6 bar, greater than or equal to 0.7 bar, greater than or equal to 0.8 bar, greater than or equal to 0.9 bar, greater than or equal to 1 bar, or greater than or equal to 2 bar prior to flowing through the water treatment unit. In some embodiments, the water from the water source comprises the one or more gases other than CO₂ at a pressure (e.g., partial pressure) of less than or equal to 5 bar, less than or equal to 2 bar, less than or equal to 1 bar, less than or equal to 0.9 bar, less than or equal to 0.8 bar, less than or equal to 0.7 bar, less than or equal to 0.6 bar, less than or equal to 0.5 bar, less than or equal to 0.4 bar, less than or equal to 0.3 bar, less than or equal to 0.2 bar, or less than or equal to 0.1 bar prior to flowing through the water treatment unit. Combinations of the above recited ranges are possible (e.g., the water from the water source comprises the one or more gases other than CO₂ at a pressure (e.g., partial pressure) of greater than or equal to 0.01 bar and less than or equal to 5 bar prior to flowing through the water treatment unit, the water from the water source comprises the one or more gases other than CO₂ at a pressure (e.g., partial pressure) of greater than or equal to 0.2 bar and less than or equal to 0.8 bar prior to flowing through the water treatment unit). Other ranges are also possible.

The water from the water source may comprise one or more carbon-containing species prior to flowing the water through the water treatment unit. The one or more carbon-containing species may be any of a variety of suitable DICs. In certain embodiments, for example, the one or more carbon-containing species comprise CO₂, bicarbonate (HCO₃⁻), and/or carbonate (CO₃²⁻). Other carbon-containing species are also possible.

The water from the water source may comprise the one or more carbon-containing species prior to flowing through the water treatment unit at any of a variety of suitable concentrations. In certain embodiments, for example, the concentration of the one or more carbon-containing species in the water from the water source prior to flowing through the water treatment unit may be greater than or equal to 0.1 mM, greater than or equal to 0.5 mM, greater than or equal to 1 mM, greater than or equal to 1.5 mM, greater than or equal to 2 mM, greater than or equal to 2.5 mM, greater than or equal to 5 mM, or greater than or equal to 10 mM. In some embodiments, the concentration of the one or more carbon-containing species in the water from the water source prior to flowing through the water treatment unit may be less than or equal to 20 mM, less than or equal to 10 mM, less than or equal to 5 mM, less than or equal to 3 mM, less than or equal to 2.5 mM, less than or equal to 2 mM, less than or equal to 1.5 mM, less than or equal to 1 mM, or less than or equal to 0.5 mM. Combinations of the above recited ranges are possible (e.g., the concentration of the one or more carbon-containing species in the water from the water source prior to flowing through the water treatment unit may be greater than or equal to 0.1 mM and less than or equal to 20 mM, the concentration of the one or more carbon-containing species in the water from the water source prior flowing through the water treatment unit may be greater than or equal to 1.5 mM and less than or equal to 2.5 mM). Other ranges are also possible.

The water from the water source (e.g., prior to flowing through the water treatment unit) may have a first pH level. The first pH level of the water may be any of a variety of suitable pH values. In certain embodiments, the first pH level is a neutral or basic pH. For example, in some embodiments, the first pH level is greater than or equal to 7, greater than or equal to 7.5, greater than or equal to 8, or greater than or equal to 8.5, or greater than or equal to 9. In certain embodiments, the first pH level is less than or equal to 9.5, less than or equal to 9, less than or equal to 8.5, less than or equal to 8, or less than or equal to 7.5. Combinations of the above recited ranges are possible (e.g., the first pH level is greater than or equal to 7 and less than or equal to 9.5, the first pH level is greater than or equal to 8 and less than or equal to 9). Other ranges are also possible.

In some embodiments, the water treatment unit is configured to acidify water flowing through the water treatment unit. For example, in accordance with certain embodiments, the water treatment unit is configured to adjust the pH of the water flowing through the water treatment unit from the first pH level to a second pH level that is lower than the first pH level. In certain embodiments, the water flowing through the water treatment unit comprises the one or more carbon-containing species, and adjusting the pH of the water from the first pH level to the second pH level that is lower than the first pH converts at least some of the one or more carbon-containing species to CO₂.

The water treatment unit may acidify the water by any of a variety of suitable means that would be known to a person of ordinary skill in the art. In certain embodiments, for example, the water treatment unit utilizes one or more acids (e.g., hydrochloric acid, sulfuric acid, nitric acid, and the like) to acidify the water. In some embodiments, the water treatment unit utilizes an electrochemical-based acidification process via one or more reactive electrodes and/or water splitting (e.g., bipolar membrane water splitting).

The second pH level of the water (e.g., after flowing through the water treatment unit) may be any of a variety of suitable pH values. In some embodiments, the first pH level is a neutral or acidic pH. For example, in certain embodiments, the second pH level is less than or equal to 7, less than or equal to 6.5, less than or equal to 6, less than or equal to 5.5, less than or equal to 5, or less than or equal to 4.5. In some embodiments, the second pH level is greater than or equal to 4, greater than or equal to 4.5, greater than or equal to 5, greater than or equal to 5.5, greater than or equal to 6, or greater than or equal to 6.5. Combinations of the above recited ranges are possible (e.g., the second pH level is less than or equal to 7 and greater than or equal to 4, the second pH level is less than or equal to 6 and greater than or equal to 5). Other ranges are also possible.

In certain embodiments, the water may comprise CO₂ (e.g., dissolved CO₂) after flowing through the water treatment unit. In some embodiments, after the flowing through the water treatment unit, the water comprises a higher partial pressure of CO₂ as compared to the partial pressure of CO₂ in the water prior to flowing through the water treatment unit. For example, in some embodiments, at least some of the carbon-containing species in the water from the water source are converted to CO₂ after flowing through the water treatment unit.

The water may comprise CO₂ at any of a variety of suitable pressures (e.g., partial pressures) after flowing through the water treatment unit. In some embodiments, for example, the water from the water source comprises CO₂ at a pressure (e.g., partial pressure) of greater than or equal to 0.01 bar, greater than or equal to 0.05 bar, greater than or equal to 0.06 bar, greater than or equal to 0.07 bar, greater than or equal to 0.08 bar, greater than or equal to 0.09, greater than or equal to 0.1 bar, greater than or equal to 0.2 bar, greater than or equal to 0.3 bar, greater than or equal to 0.4 bar, greater than or equal to 0.5 bar, greater than or equal to 1 bar, or greater than or equal to 2 bar after to flowing through the water treatment unit. In certain embodiments, the water comprises CO₂ at a pressure (e.g., partial pressure) of less than or equal to 5 bar, less than or equal to 2 bar, less than or equal to 1 bar, less than or equal to 0.5 bar, less than or equal to 0.4 bar, less than or equal to 0.3 bar, less than or equal to 0.2 bar, less than or equal to 0.1 bar, less than or equal to 0.09 bar, less than or equal to 0.08 bar, less than or equal to 0.07 bar, less than or equal to 0.06 bar, or less than or equal to 0.05 bar after flowing through the water treatment unit. Combinations of the above recited ranges are possible (e.g., the water may comprise CO₂ at a pressure (e.g., partial pressure) of greater than or equal to 0.01 bar and less than or equal to 5 bar after flowing through the water treatment unit, the water may comprise CO₂ at a pressure (e.g., partial pressure) of greater than or equal to 0.06 bar and less than or equal to 0.08 bar after flowing through the water treatment unit). Other ranges are also possible.

The water may comprise one or more gases (e.g., one or more dissolved gases) other than CO₂ after flowing through the water treatment unit, in some embodiments. For example, in certain embodiments, the water comprises O₂, N₂, and/or combinations thereof after flowing through the water treatment unit. Other gases are also possible.

The water may comprise the one or more gases other than CO₂ (e.g., O₂ and/or N₂) at any of a variety of suitable pressures (e.g., partial pressures) after flowing through the water treatment unit. In certain embodiments, for example, the water comprises the one or more gases other than CO₂ at a pressure (e.g., partial pressure) of greater than or equal to 0.01 bar, greater than or equal to 0.1 bar, greater than or equal to 0.2 bar, greater than or equal to 0.3 bar, greater than or equal to 0.4 bar, greater than or equal to 0.5 bar, greater than or equal to 0.6 bar, greater than or equal to 0.7 bar, greater than or equal to 0.8 bar, greater than or equal to 0.9 bar, greater than or equal to 1 bar, or greater than or equal to 2 bar after flowing through the water treatment unit. In some embodiments, the water comprises the one or more gases other than CO₂ a pressure (e.g., partial pressure) of less than or equal to 5 bar, less than or equal to 2 bar, less than or equal to 1 bar, less than or equal to 0.9 bar, less than or equal to 0.8 bar, less than or equal to 0.7 bar, less than or equal to 0.6 bar, less than or equal to 0.5 bar, less than or equal to 0.4 bar, less than or equal to 0.3 bar, less than or equal to 0.2 bar, or less than or equal to 0.1 bar after flowing through the water treatment unit. Combinations of the above recited ranges are possible (e.g., the water comprises the one or more gases other than CO₂ at a pressure (e.g., partial pressure) of greater than or equal to 0.01 bar and less than or equal to 5 bar after flowing through the water treatment unit, the water comprises the one or more gases other than CO₂ at a pressure (e.g., partial pressure) of greater than or equal to 0.2 bar and less than or equal to 0.8 bar after flowing through the water treatment unit). Other ranges are also possible.

According to some embodiments, the partial pressure of the one or more gases other than CO₂ (e.g., O₂ and/or N₂) after flowing through the water treatment unit may be the same or substantially the same as the partial pressure of the one or more gases other than CO₂ prior to flowing through the water treatment unit.

In some embodiments, the water comprises no or substantially no carbon-containing species (e.g., DICs such as CO₂, HCO₃⁻, and/or CO₃²⁻) after flowing through water treatment unit. In certain embodiments, for example, the carbon-containing species in the water prior to flowing through the water treatment unit are converted to CO₂ (e.g., by the water treatment unit).

According to certain embodiments, the system does not comprise a degasification unit and/or a vacuum configured to remove one or more gases (e.g., dissolved gases) from the water. In some embodiments, for example, the water used in the system may comprise one or more gases (e.g., one or more dissolved gases), as explained herein in greater detail. Advantageously, a system that does not include a degasification unit and/or a vacuum significantly reduces energy demands and overall process footprint.

Any of a variety of amounts of dissolved gases may be removed from the water from the water source prior to flowing the water through the system (e.g., through the water treatment unit, through the CO₂-extraction unit, and/or through the water regeneration unit). In some embodiments, for example, less than or equal to 90%, less than or equal to 80%, less than or equal to 70%, less than or equal to 60%, less than or equal to 50%, less than or equal to 40%, less than or equal to 30%, less than or equal to 20%, less than or equal to 10%, less than or equal to 5%, or less than or equal to 1% of dissolved gases may be removed form the water from the water source prior to flowing the water through the system. In certain embodiments, greater than or equal to 0%, greater than or equal to 1%, greater than or equal to 5%, greater than or equal to 10%, greater than or equal to 20%, greater than or equal to 30%, greater than or equal to 40%, greater than or equal to 50%, greater than or equal to 60%, greater than or equal to 70%, or greater than or equal to 80% of dissolved gases are removed from the water from the water source prior to flowing the water through the system. Combinations of the above recited ranges are possible (e.g., less than or equal to 90% and greater than or equal to 0% of dissolved gases are removed from the water from the water source prior to flowing the water through the system, less than or equal to 10% and greater than or equal to 1% of dissolved gases are removed from the water from the water source prior to flowing the water through the system). Other ranges are also possible.

According to certain embodiments, the system comprises a CO₂-extraction unit. Referring to FIG. 1, for example, system 100a comprises CO₂-extraction unit 106. In some embodiments, the CO₂-extraction unit is configured to remove CO₂ from water, which is explained herein in greater detail.

According to some embodiments, the CO₂-extraction unit comprises a water flow chamber. Referring to FIG. 1, for example, CO₂-extraction unit 106 comprises water flow chamber 108. The water flow chamber may be configured to comprise water, in some embodiments. In other embodiments, the water flow chamber comprises water. According to certain embodiments, for example, an outlet of the water treatment unit is fluidically connected to an inlet of the water flow chamber such that water flowing from the water treatment unit flows into the water flow chamber. Referring, for example, to FIG. 1, outlet 110a of water treatment unit 102 may be fluidically connected to inlet 104b of water flow chamber 108.

In certain embodiments, the CO₂-extraction unit comprises a CO₂-extraction solution flow chamber. Referring to FIG. 1, for example, CO₂-extraction unit 106 comprises CO₂-extraction solution flow chamber 112. The CO₂-extraction solution flow chamber may, in some embodiments, be configured to comprise a CO₂-extraction solution comprising a CO₂-extractor. In other embodiments, the CO₂-extraction solution flow chamber comprises a CO₂-extraction solution comprising a CO₂-extractor. Suitable CO₂-extraction solutions and CO₂-extractors are explained herein in greater detail.

In some embodiments, the CO₂-extraction unit comprises a CO₂-permeable membrane. As shown in FIG. 1, for example, CO₂-extraction unit 106 comprises CO₂-permeable membrane 114. The CO₂-permeable membrane is permeable to CO₂, in some embodiments. In certain embodiments, the CO₂-permeable membrane is at least partially permeable to one or more additional gases. For example, in some embodiments, the CO₂-permeable membrane is at least partially permeable to O₂ and/or N₂.

The water flow chamber and the CO₂-extraction solution flow chamber may, in some embodiments, be separated by the CO₂-permeable membrane. Referring to FIG. 1, for example, water flow chamber 108 and CO₂-extraction solution flow chamber 112 are separated by CO₂-permeable membrane 114. According to some embodiments, the CO₂-permeable membrane may advantageously be configured to: (i) prevent water flowing in the water flow chamber from mixing with the CO₂-extraction solution flowing in the CO₂-extraction solution flow chamber; and (ii) prevent the CO₂-extraction solution flowing in the CO₂-extraction solution flow chamber from mixing with the water flowing in the water flow chamber. For example, in some embodiments, the CO₂-permeable comprises a plurality of pores. Without wishing to be bound by theory, the plurality of pores may provide resistance to mass transfer across the semi-permeable membrane. In certain embodiments, the plurality of pores comprise a gas. For example, the plurality of pores may comprise air (e.g., air plastron), in some embodiments.

According to some embodiments, the CO₂-permeable membrane comprises a first surface and a second surface. For example, as shown in FIG. 1. CO₂-permeable membrane 114 comprises first surface 116 and second surface 118. In certain embodiments, the first surface of the CO₂-permeable membrane is substantially opposite the second surface of the CO₂-permeable membrane. Referring, for example, to FIG. 1, first surface 116 of CO₂-permeable membrane 114 is substantially opposite second surface 118 of CO₂-permeable membrane 114.

According to some embodiments, the water flow chamber is configured to flow water comprising CO₂ in contact with the first surface of the CO₂-permeable membrane. For example, as shown in FIG. 1, water flow chamber 108 is configured to flow water comprising CO₂ in contact with first surface 116 of CO₂-permeable membrane 114.

In certain embodiments, the CO₂-extraction solution flow chamber is configured to flow the CO₂-extraction solution in contact with the second surface of the CO₂-permeable membrane. Referring to FIG. 1, for example, CO₂-extraction solution flow chamber 112 is configured to flow the CO₂-extraction solution in contact with second surface 118 of CO₂-permeable membrane 114.

As described above, the CO₂-extraction unit is configured to remove CO₂ from water across the CO₂-permeable membrane into the CO₂-extraction solution. In accordance with certain embodiments, for example, the CO₂-permeable membrane is configured such that CO₂ passes through the CO₂-permeable membrane from the water (e.g., flowing in the water flow chamber) into the CO₂-extraction solution (e.g., flowing in the CO₂-extraction solution chamber). In some embodiments, after the CO₂ passes through the CO₂-permeable membrane from the water into the CO₂-extraction solution, the CO₂ complexes with the CO₂-extractor to produce a CO₂-complexed CO₂-extractor.

In some embodiments, the CO₂-permeable membrane is a symmetric or substantially symmetric membrane. For example, in certain embodiments, the CO₂-permeable membrane comprises a plurality of pores having symmetric or essentially symmetric pore structures. In other embodiments, the CO₂-permeable membrane is an asymmetric membrane. In certain embodiments, for example, the CO₂-permeable membrane comprises a plurality of pores having asymmetric pore structures such that the pores gradually become larger across the membrane from the water flow chamber to the CO₂-extraction solution flow chamber. According to certain embodiments, the asymmetric membrane may comprise two layers. For example, in some embodiments, the asymmetric membrane comprises a first layer having a plurality of pores with a first size distribution (e.g., in contact with the water flowing in the water flow chamber) and a second layer having a plurality of pores with a second size distribution, wherein the second size distribution is larger than the first size distribution (e.g., in contact with the CO₂-extraction solution flowing in the CO₂-extraction solution flow chamber)

The CO₂-permeable membrane may comprise any of a variety of suitable materials. In certain embodiments, for example, the CO₂-permeable membrane comprises a hollow-fiber membrane (HFM). The CO₂-permeable membrane may comprise a hydrophobic material, in some embodiments. In some embodiments, for example, the CO₂-permeable membrane comprises a polymer. Suitable polymers include, but are not limited to, polypropylene and/or polytetrafluoroethylene. Other materials are also possible and would be known to a person of ordinary skill in the art.

As described above, the CO₂-extraction unit comprises a CO₂-extraction solution comprising a CO₂-extractor. In certain embodiments, for example, the CO₂-extraction solution comprises a CO₂-extractor dissolved, suspended, and/or dispersed in the CO₂-extraction solution.

The CO₂-extraction solution may comprise any of a variety of suitable solvents. The solvent of the CO₂-extraction solution may depend, in some embodiments, on the CO₂-extractor. According to some embodiments, the solvent is a non-volatile solvent (e.g., under ambient conditions). In certain embodiments, the CO₂-extraction solution comprises an organic, aprotic solvent. In other embodiments, the CO₂-extraction solution comprises an aqueous, protic solvent.

According to some embodiments, the CO₂-extractor has an affinity for complexing CO₂. In certain embodiments, for example, the CO₂-extractor has a comparatively higher affinity for complexing CO₂ as compared to O₂ and/or N₂.

The CO₂-extractor may comprise any of a variety of suitable materials. According to certain embodiments, the CO₂-extractor is non-volatile (e.g., under ambient conditions). In some embodiments, the CO₂-extractor comprises a redox active moiety (e.g., an organic redox active moiety). In certain embodiments, the CO₂-extractor comprises a quinone (e.g., 1,4-naphthoquinone, antraquinone-2,7-disulfonic acid, and the like), a disulfide (e.g., diphenyl sulfide and the like), and/or a bipyridine (e.g., 4,4′-bipyridine and the like). The CO₂-extractor comprises an organic dye (e.g., neutral red, chloranil, and the like), in accordance with certain embodiments. In some embodiments, the CO₂-extractor comprises an amine (e.g., ethylenediamine and the like). In certain embodiments, the CO₂-extractor comprises CO₃²⁻. Other quinones, disulfides, bipyridines, and/or amines are also possible and would be known to a person of ordinary skill in the art.

According to some embodiments, the CO₂-extraction solution comprises an organic, aprotic solvent and the CO₂-extractor comprises a redox active moiety (e.g., an organic redox active moiety) such as a quinone, a disulfide, and/or a bipyridine. In certain embodiments, the CO₂-extraction solution comprises an aqueous, protic solvent and the CO₂-extractor comprises CO₃²⁻.

According to certain embodiments, the system comprises a CO₂-extraction solution regeneration unit. Referring to FIG. 1, for example, system 100a comprises CO₂-extraction solution regeneration unit 120. In some embodiments, the CO₂-extraction solution regeneration unit is configured to release CO₂ from the CO₂-complexed CO₂-extractor and to regenerate the CO₂-extractor.

According to some embodiments, an outlet of the CO₂-extraction solution flow chamber is fluidically connected to an inlet of the CO₂-extraction solution regeneration unit such that the CO₂-extraction solution (e.g., comprising the CO₂-complexed CO₂-extractor) flowing from the CO₂-extraction solution flow chamber flows into the CO₂-extraction solution regeneration unit. Referring to FIG. 1, for example, outlet 110b of CO₂-extraction solution flow chamber 112 is fluidically connected to inlet 104c of CO₂-extraction solution regeneration unit 120.

The CO₂-extraction solution regeneration unit may be configured to release CO₂ from the CO₂-complexed CO₂-extractor and to regenerate the CO₂-extractor by any of a variety of suitable means. In some embodiments, for example, the CO₂-extraction solution regeneration unit comprises an electrochemical cell. In certain embodiments, the CO₂-extractor may comprise a redox active moiety (e.g., a quinone, a disulfide, a bipyridine) that complexes CO₂ in the CO₂-extraction unit, as described herein, in an activated (e.g., reduced) form, thereby producing the CO₂-complexed CO₂-extractor. The electrochemical cell may be configured, in some embodiments, to oxidize the CO₂-complexed activated (e.g., reduced) CO₂-extractor in an anode chamber to produce a deactivated (e.g., neutral) CO₂-extractor that releases CO₂ (e.g., from the quinone, a disulfide, and/or bipyridine). In certain embodiments, the electrochemical cell may be configured to reduce the deactivated (e.g., neutral) CO₂-extractor in a cathode chamber to regenerate the activated (e.g., reduced) CO₂-extractor.

In some embodiments, the CO₂-extractor comprises an amine (e.g., ethylenediamine) that complexes CO₂ in the CO₂-extraction unit, as described herein, thereby producing the CO₂-complexed CO₂-extractor (e.g., carbamate). The electrochemical cell may be configured, in some embodiments, to oxidize a metal (e.g., a metal electrode), such as copper (Cu), in an anode chamber to produce a metal-amine (e.g., Cu(II)-ethylenediamine) that releases CO₂ (e.g., from the carbamate). In certain embodiments, the electrochemical cell may be configured to reduce the metal-amine in a cathode chamber to regenerate the CO₂-extractor (e.g., the amine) and the metal (e.g., Cu). This process is known as the EMAR process and is described in further detail in U.S. patent application Ser. No. 16/150,186, filed Oct. 2, 2018, published as U.S. Patent Publication No 2019/0099711 on Apr. 4, 2019, issued as U.S. Pat. No. 11,446,604 on Sep. 20, 2022, and entitled “Methods and Systems for Removing CO₂ From a Feed Gas,” which is incorporated herein by reference in its entirety.

In some embodiments, the CO₂-extractor comprises CO₃²⁻ that complexes CO₂ in the CO₂-extraction unit, as described herein, via a pH swing process, thereby producing the CO₂-complexed CO₂-extractor (e.g., two equivalents of HCO₃⁻). In certain embodiments, the electrochemical cell may be configured to generate a proton (H⁺) via one or more intercalation electrodes to produce one equivalent of HCO₃⁻ that releases CO₂ (e.g., from the two equivalents of HCO₃⁻). In some embodiments, the electrochemical cell may be configured to remove a proton via the one or more intercalation electrodes to regenerate the CO₂-extractor (e.g., CO₃²⁻).

According to some embodiments, the CO₂-extraction solution regeneration unit comprises a thermal regeneration unit. In certain embodiments, for example, the CO₂-extractor may comprise an amine (e.g., ethylenediamine) that complexes CO₂ in the CO₂-extraction unit, as described herein, thereby producing the CO₂-complexed CO₂-extractor (e.g., carbamate). The thermal regeneration unit may be configured, in some embodiments, to release CO₂ from the CO₂-complexed CO₂-extractor via an amine scrubbing process.

According to certain embodiments, the CO₂-extraction solution regeneration unit comprises bipolar membrane electrodialysis unit.

According to certain embodiments, the system comprises a flash tank. Referring to FIG. 1, for example, system 100a comprises flash tank 122. The flash tank may be configured, in some embodiments, to remove CO₂ (e.g., released from the CO₂-extractor) from the CO₂-extraction solution.

In some embodiments, an outlet of the CO₂-extraction solution regeneration unit is fluidically connected to an inlet of the flash tank such that the CO₂-extraction solution (e.g., comprising CO₂ released from the CO₂-extractor and the CO₂-extractor) flowing from the CO₂-extraction solution regeneration unit flows into the flash tank. As shown in FIG. 1, for example, outlet 110c of CO₂-extraction solution regeneration unit 120 is fluidically connected to inlet 104d of flash tank 122.

According to some embodiments, an outlet of the flash tank is fluidically connected to an inlet of the CO₂-extraction solution flow chamber such that the CO₂-extraction solution (e.g., comprising the CO₂-extractor) flowing from the flash tank flows into the CO₂-extraction solution flow chamber. For example, referring to FIG. 1, outlet 110d of flash tank 122 is fluidically connected to inlet 104e of CO₂-extraction solution flow chamber 112. In some embodiments, after flowing from the flash tank to the CO₂-extraction solution flow chamber, the CO₂-extraction solution comprising the CO₂-extractor may be configured to remove CO₂ from water. The system may therefore be configured as a continuous process, in some embodiments, so that CO₂ is continuously removed from the water flowing in the water chamber of the CO₂-extraction unit by the CO₂-extraction solution comprising the CO₂-extractor flowing in the CO₂-extraction solution flow chamber.

In accordance with certain embodiments, the system comprises a compressor. For example, referring to FIG. 1, system 100a comprises compressor 124. The compressor may be configured, in some embodiments, to compress the CO₂ removed by the flash tank.

In some embodiments, a gaseous outlet of the flash tank is fluidically connected to a gaseous inlet of the compressor such the CO₂ flowing from the flash tank flows into the compressor. As shown in FIG. 1, for example, gaseous outlet 126a of flash tank 122 is fluidically connected to gaseous inlet 128 of compressor 124.

The pressure of the CO₂ flowing from the flash tank into the compressor may be any of a variety of suitable pressures. In some embodiments, for example, the pressure of the CO₂ flowing from the flash tank into the compressor may be greater than or equal to 0.1 bar, greater than or equal to 0.5 bar, greater than or equal to 0.6 bar, greater than or equal to 0.7 bar, greater than or equal to 0.8 bar, greater than or equal to 0.9 bar, greater than or equal to 1 bar, greater than or equal to 1.5 bar, greater than or equal to 2 bar, greater than or equal to 2.5 bar, greater than or equal to 3 bar, greater than or equal to 3.5 bar, greater than or equal to 4 bar, or greater than or equal to 4.5 bar. In certain embodiments, the pressure of the CO₂ flowing from the flash tank into the compressor may be less than or equal to 5 bar, less than or equal to 4.5 bar, less than or equal to 4 bar, less than or equal to 3.5 bar, less than or equal to 3 bar, less than or equal to 2.5 bar, less than or equal to 2 bar, less than or equal to 1.5 bar, less than or equal to 1 bar, less than or equal to 0.9 bar, less than or equal to 0.8 bar, less than or equal to 0.7 bar, less than or equal to 0.6 bar, or less than or equal to 0.5 bar. Combinations of the above recited ranges are possible (e.g., the pressure of the CO₂ flowing from the flash tank into the compressor may be greater than or equal to 0.1 bar and less than or equal to 5 bar, the pressure of the CO₂ flowing from the flash tank into the compressor may be greater than or equal to 0.9 bar and less than or equal to 1.5 bar). Other ranges are also possible.

According to some embodiments, a gaseous outlet of the compressor may be fluidically connected to a CO₂-collection unit such that the compressed CO₂ flowing from the compressor may be collected in the CO₂-collection unit. Referring to FIG. 1, for example, gaseous outlet 126b of compressor 124 may be fluidically connected to a CO₂-collection unit (not shown in FIG. 1). In certain embodiments, the collected CO₂ in the CO₂-collection unit may be used for geologic storage and/or industry utilization.

The pressure of the CO₂ flowing from the compressor into the CO₂-collection unit may be any of a variety of suitable pressures. In some embodiments, for example, the pressure of the CO₂ flowing from the compressor into the CO₂-collection unit may be greater than or equal to 5 bar, greater than or equal to 10 bar, greater than or equal to 20 bar, greater than or equal to 50 bar, greater than or equal to 100 bar, greater than or equal to 150 bar, or greater than or equal to 200 bar. In certain embodiments, the pressure of the CO₂ flowing from the compressor into the CO₂-collection unit may be less than or equal to 250 bar, less than or equal to 200 bar, less than or equal to 150 bar, less than or equal to 100 bar, less than or equal to 50 bar, less than or equal to 20 bar, or less than or equal to 10 bar. Combinations of the above recited ranges are possible (e.g., the pressure of the CO₂ flowing from the compressor into the CO₂-collection unit may be greater than or equal to 5 bar and less than or equal to 250 bar, the pressure of the CO₂ flowing from the compressor into the into the CO₂-collection unit may be greater than or equal to 100 bar and less than or equal to 150 bar). Other ranges are also possible.

According to certain embodiments, the system comprises a water regeneration unit for dc-acidification water (e.g., a water de-acidification unit). Referring, for example, to FIG. 1, system 100a comprises water regeneration unit 130.

In certain embodiments, an outlet of the water flow chamber is fluidically connected to an inlet of the water regeneration unit such that water flowing from the water flow chamber flows into the water regeneration unit. As shown in FIG. 1, for example, outlet 110e of water flow chamber 108 is fluidically connected to inlet 104f of water regeneration unit 130.

In some embodiments, the water regeneration unit is configured to de-acidify water flowing through the water regeneration unit. For example, in accordance with certain embodiments, the water regeneration unit is configured to adjust the pH of water flowing through the water regeneration unit from the second pH level to the first pH level.

The water regeneration unit may de-acidify the water by any of a variety of suitable means that would be known to a person of ordinary skill in the art. In some embodiments, for example, the water regeneration unit utilizes one or more bases (e.g., potassium hydroxide, sodium hydroxide, and the like) to de-acidify the water.

The second pH level of the water (e.g., prior to flowing through the water regeneration unit) may be any of the previously described pH values with respect to the water treatment unit (e.g., the second pH level is less than or equal to 7 and greater than or equal to 4).

The first pH level of the water (e.g., after flowing through the water regeneration unit) may be any of the previously described pH values with respect to the water treatment unit (e.g., the first pH level is greater than or equal to 7 and less than or equal to 9.5).

According to certain embodiments, the water comprises no or substantially no CO₂ (e.g., dissolved CO₂) after flowing through the water regeneration unit.

The water may comprise one or more gases (e.g., one or more dissolved gases) other than CO₂ after flowing through the water regeneration unit, in some embodiments. For example, in certain embodiments, the water comprises O₂, N₂, and/or combinations thereof after flowing through the water regeneration unit. Other gases are also possible.

The water may comprise the one or more gases other than CO₂ (e.g., O₂ and/or N₂) at any of a variety of suitable pressures (e.g., partial pressures) after flowing through the water regeneration unit. In certain embodiments, for example, the water comprises the one or more gases other than CO₂ at a pressure (e.g., partial pressure) of greater than or equal to 0.01 bar, greater than or equal to 0.1 bar, greater than or equal to 0.2 bar, greater than or equal to 0.3 bar, greater than or equal to 0.4 bar, greater than or equal to 0.5 bar, greater than or equal to 0.6 bar, greater than or equal to 0.7 bar, greater than or equal to 0.8 bar, greater than or equal to 0.9 bar, greater than or equal to 1 bar, or greater than or equal to 2 bar after flowing through the water regeneration unit. In some embodiments, the water comprises the one or more gases other than CO₂ a pressure (e.g., partial pressure) of less than or equal to 5 bar, less than or equal to 2 bar, less than or equal to 1 bar, less than or equal to 0.9 bar, less than or equal to 0.8 bar, less than or equal to 0.7 bar, less than or equal to 0.6 bar, less than or equal to 0.5 bar, less than or equal to 0.4 bar, less than or equal to 0.3 bar, less than or equal to 0.2 bar, or less than or equal to 0.01 bar after flowing through the water regeneration unit. Combinations of the above recited ranges are possible (e.g., the water comprises the one or more gases other than CO₂ at a pressure (e.g., partial pressure) of greater than or equal to 0.01 bar and less than or equal to 5 bar after flowing through the water regeneration unit, the water comprises the one or more gases other than CO₂ at a pressure (e.g., partial pressure) of greater than or equal to 0.4 bar and less than or equal to 0.6 bar after flowing through the water regeneration unit). Other ranges are also possible.

In some embodiments, the water comprises no or substantially no carbon-containing species (e.g., DICs such as CO₂, HCO₃⁻, and/or CO₃²⁻) after flowing through water regeneration unit.

According to some embodiments, an outlet of the water regeneration unit is fluidically connected to a water source such that water flowing from the water regeneration unit (e.g., at the first pH level) flows into a water source. Referring to FIG. 1, for example, outlet 110f of water regeneration unit 130 may be fluidically connected to a water source (not shown in FIG. 1). The water source may be any of the previously described water sources with respect to the water treatment unit (e.g., a sea, an ocean, a river, a stream, a lake, a pond, a reservoir, a spring, ground water, and the like).

The water source fluidically connected to the inlet of the water treatment unit may be the same or different than the water source fluidically connected to the outlet of the water regeneration unit. Referring to FIG. 1, for example, the water source fluidically connected to inlet 104a of water treatment unit 102 may be the same or different than the water source fluidically connected to outlet 110f of water regeneration unit 130.

According to certain embodiments, the system may comprise one or more fluid pumps configured to facilitate the flow of a fluid (e.g., the water, the CO₂-extraction solution) through the system. For example, in certain embodiments, one or more fluid pumps may be associated with the water treatment unit, the CO₂-extraction unit, the CO₂-solution regeneration unit (e.g., electrochemical cell), the flash tank, and/or the water regeneration unit to facilitate the flow of a fluid through each component of the system.

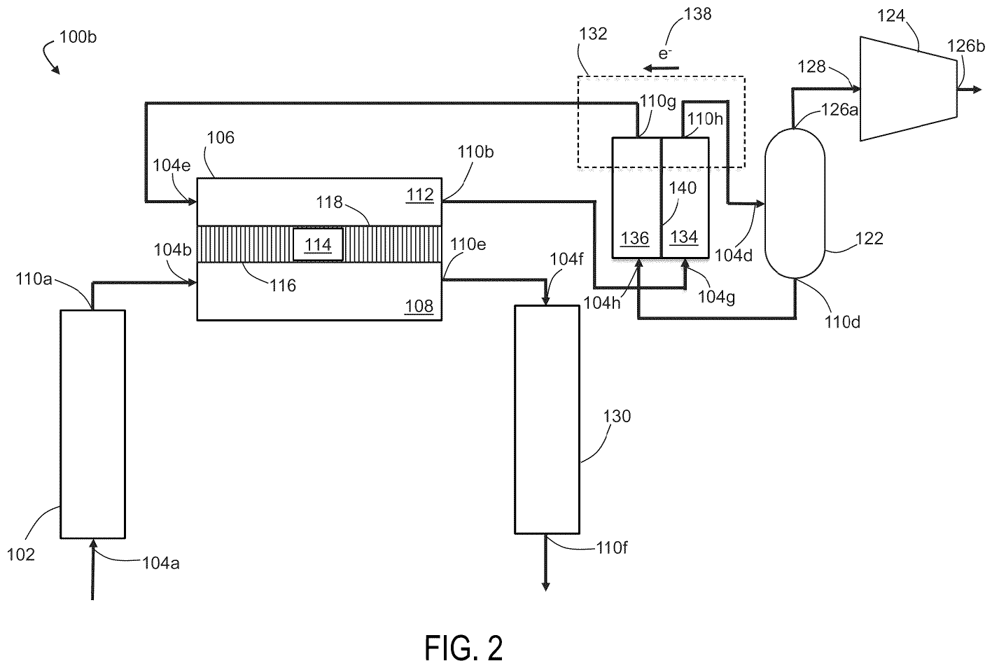

As described above, the CO₂-extraction solution regeneration unit may comprise an electrochemical cell, in accordance with certain embodiments. FIG. 2 shows a schematic diagram of an electrochemical system for removing CO₂ from water, in accordance with certain embodiments. As shown, for example, in FIG. 2, system 100b comprises electrochemical cell 132, in some embodiments. In some embodiments, the electrochemical cell is fluidically connected to the CO₂-extraction unit. For example, referring to FIG. 2, electrochemical cell 132 is fluidically connected to CO₂-extraction unit 106.

According to certain embodiments, the electrochemical cell comprises an anode chamber and a cathode chamber. As shown, for example, in FIG. 2, electrochemical cell 132 comprises anode chamber 134 and cathode chamber 136.

According to some embodiments, the anode chamber comprises a first electrode (e.g., an anode). The anode chamber may comprise any of a variety of suitable first electrode materials. In certain embodiments, for example, the first electrode comprises a carbon-based material (e.g., a graphite-based material), such as a carbon cloth, a carbon paper, a carbon textile, a carbon felt, and the like. In some embodiments, the first electrode comprises a material capable of intercalating protons (e.g., MnO₂, TiO₂, and the like), a reactive material (e.g., bismuth (Bi)), and/or a metal (e.g., Cu). Other materials are also possible.

According to some embodiments, an outlet of the CO₂-extraction unit (e.g., an outlet of the CO₂-extraction solution flow chamber) is fluidically connected to an inlet of the anode chamber such that the CO₂-extraction solution comprising the CO₂-complexed CO₂-extractor flowing from the CO₂-extraction solution flow chamber flows into the anode chamber. Referring to FIG. 2, for example, outlet 110b of CO₂-extraction solution flow chamber 112 is fluidically connected to inlet 104g of anode chamber 134.

In certain embodiments, the system is configured to flow the CO₂-extraction solution comprising the CO₂-complexed CO₂-extractor from the CO₂-extraction unit (e.g., from an outlet of the CO₂-extraction solution flow chamber) to the anode chamber (e.g., to an inlet of the anode chamber). Referring to FIG. 2, for example, system 100b is configured to flow the CO₂-extraction solution comprising the CO₂-complexed CO₂-extractor from outlet 110b of CO₂-extraction solution flow chamber 112 to inlet 104g of anode chamber 134.

In some embodiments, the CO₂-extraction solution is an electrolyte solution for the electrochemical cell. In certain embodiments, the CO₂-extraction solution may comprise an electrolyte salt.

Any of a variety of suitable electrolyte salts may be employed. In some embodiments, the electrolyte salt may comprise an alkali metal salt and/or an alkaline earth metal salt. For example, the electrolyte salt may comprise an alkali metal and/or an alkaline earth metal salt of nitrate, borate, a halide, phosphate, a phosphonate, carbonate, sulfate, and/or perchlorate. Other electrolyte salts are also possible.

According to some embodiments, upon application of a potential across the electrochemical cell, the anode chamber may be configured to oxidize at least a portion of the CO₂-extraction solution in the anode chamber to release CO₂ from the CO₂-complexed CO₂-extractor. Referring, for example, to FIG. 2, upon application of potential 138 across electrochemical cell 132, anode chamber 134 may be configured to oxidize at least a portion of the CO₂-extraction solution in anode chamber 134 to release CO₂ from the CO₂-complexed CO₂-extractor.

In some non-limiting embodiments, the CO₂-extractor may comprise a redox active moiety (e.g., a quinone, a disulfide, and/or a bipyridine). The redox active CO₂-extractor may, in some embodiments, complex CO₂ in the CO₂-extraction unit, as described herein, in an activated (e.g., reduced) form, thereby producing the CO₂-complexed CO₂-extractor. In certain embodiments, upon application of the potential across the electrochemical cell, the anode chamber may be configured to oxidize at least a portion of the CO₂-extraction solution to release CO₂ from the CO₂-complexed CO₂-extractor, thereby producing a deactivated (e.g., neutral) CO₂-extractor.

In certain embodiments, an outlet of the anode chamber is fluidically connected to an inlet of the flash tank such that the CO₂-extraction solution (e.g., comprising CO₂ released from the CO₂-extractor and the deactivated CO₂-extractor) flowing from the anode chamber flows into the flash tank (e.g., to remove CO₂ released from the CO₂-extractor). Referring, for example, to FIG. 2, outlet 110h of anode chamber 134 is fluidically to inlet 104d of flash tank 122.

In certain embodiments, the cathode chamber comprises a second electrode (e.g., a cathode). The cathode chamber may comprise any of a variety of suitable second electrode materials. In certain embodiments, for example, the second electrode comprises a carbon-based material (e.g., a graphite-based material), such as a carbon cloth, a carbon paper, a carbon textile, a carbon felt, and the like. In some embodiments, the second electrode comprises a material capable of intercalating protons (e.g., MnO₂, TiO₂, and the like), a reactive material (e.g., bismuth (Bi)), and/or a metal (e.g., Cu). Other materials are also possible.

According to certain embodiments, an outlet of the flash tank is fluidically connected to an inlet of the cathode chamber such that the CO₂-extraction solution (e.g., comprising the deactivated CO₂-extractor) flowing from the flash tank flows into the cathode chamber. Referring, for example, to FIG. 2, outlet 110d of flash tank 122 is fluidically connected to inlet 104h of cathode chamber 136.

In certain embodiments, upon application of a potential across the electrochemical cell, the cathode chamber may be configured to reduce at least a portion of the CO₂-extraction solution in the cathode chamber to regenerate the CO₂-extractor. For example, referring to FIG. 2, upon application of potential 138 across electrochemical cell 132, cathode chamber 136 may be configured to reduce at least a portion of the CO₂-extraction solution in cathode chamber 136 to regenerate the CO₂-extractor.

In certain non-limiting embodiments, the CO₂-extractor may comprise a redox active moiety (e.g., a quinone, a disulfide, and/or a bipyridine). The redox active CO₂-extractor may, in some embodiments, release CO₂ in the anode chamber, as described herein, thereby producing the deactivated (e.g., neutral) CO₂-extractor. In some embodiments, upon application of the potential across the electrochemical cell, the cathode chamber may be configured to reduce at least a portion of the CO₂-extraction solution to regenerate the CO₂-extractor, thereby producing the activated (e.g., reduced) CO₂-extractor.

According to some embodiments, an outlet of the cathode chamber is fluidically connected to an inlet of the CO₂-extraction solution flow chamber such that the CO₂-extraction solution (e.g., comprising the activated CO₂-extractor) flowing from the cathode chamber flows into the CO₂-extraction solution flow chamber. Referring, for example, to FIG. 2, outlet 110g of cathode chamber 136 is fluidically connected to inlet 104e of CO₂-extraction solution flow chamber 112.

According to certain embodiments, the system is configured to flow the CO₂-extraction solution comprising the CO₂-extractor (e.g., activated CO₂-extractor) from the cathode chamber (e.g., from an outlet of the cathode chamber) to the CO₂-extraction solution flow chamber (e.g., to an inlet of the CO₂-extraction solution flow chamber). Referring to FIG. 2, for example, system 100b may be configured to flow the CO₂-extraction solution comprising the CO₂-extractor from outlet 110g of cathode chamber 136 to inlet 104e of CO₂-extraction solution flow chamber 112.

According to certain embodiments, the electrochemical cell may comprise a separator. Referring to FIG. 2, for example, electrochemical cell 132 comprises separator 140. The separator may be configured to separate the anode chamber from the cathode chamber. For example, as shown in FIG. 2, separator 140 is configured to separate anode chamber 134 from cathode chamber 136.

Any of a variety of suitable separator materials may be utilized. In certain embodiments, for example, the separator comprises a cation exchange membrane or an anion exchange membrane. In some embodiments, the separator comprises Nafion. Other materials are also possible and would be known to a person of ordinary skill in the art.

According to certain embodiments, a method for removing CO₂ from water is described. In some embodiments, the method comprises adjusting the pH of water comprising one or more carbon-containing species (e.g., IDCs such as CO₂, HCO₃⁻, and/or CO₃²⁻) from a first pH level (e.g., greater than or equal to 7 and less than or equal to 9.5) to a second pH level (e.g., less than or equal to 7 and greater than or equal to 4) that is lower than the first pH level to convert at least some of the one or more carbon-containing species to the CO₂. In certain embodiments, adjusting the pH of the water from the first pH level to the second pH level comprises flowing the water (e.g., from a water source) through a water treatment unit configured to acidify the water. Referring to FIG. 1, for example, adjusting the pH of the water from the first pH level to the second pH level comprises flowing the water (e.g., from a water source, not shown in FIG. 1) through water treatment unit 102 configured to acidify the water (e.g., via inlet 104a).

According to certain embodiments, the method comprises exposing the water comprising the CO₂ to a CO₂-extraction unit comprising a CO₂-permeable membrane. In some embodiments, exposing the water comprising the CO₂ to the CO₂-extraction unit comprises flowing the water from an outlet of the water treatment unit to an inlet of the water flow chamber. Referring to FIG. 1, for example, exposing the water comprising the CO₂ to CO₂-extraction unit 106 comprises flowing the water comprising the CO₂ from outlet 110a of water treatment unit to inlet 104b of water flow chamber 108.

In some embodiments, exposing the water comprising the CO₂ to the CO₂-extraction unit comprises contacting a first surface of the CO₂-permeable membrane with the water comprising the CO₂. For example, referring to FIG. 1, exposing the water comprising the CO₂ to CO₂-extraction unit 106 comprises contacting first surface 116 of CO₂-permeable membrane 114 with the water comprising the CO₂.

According to certain embodiments, the method comprises exposing a CO₂-extraction solution comprising a CO₂-extractor to the CO₂-extraction unit. In certain embodiments, exposing the CO₂-extraction solution comprising the CO₂-extractor to the CO₂-extraction unit comprises contacting a second surface of the CO₂-permeable membrane with the CO₂-extraction solution. As shown in FIG. 1, for example, exposing the CO₂-extraction solution comprising the CO₂-extractor to CO₂-extraction unit 106 comprises contacting second surface 118 of CO₂-permeable membrane 114 with the CO₂-extraction solution comprising the CO₂-extractor.

In some embodiments, the method comprises removing the CO₂ from the water across the CO₂-permeable membrane into the CO₂-extraction solution comprising the CO₂-extractor to produce a CO₂-complexed CO₂-extractor. In accordance with certain embodiments, removing the CO₂ from the water comprises passing the CO₂ through the CO₂-permeable membrane from the water to the CO₂-extraction solution comprising the CO₂-extractor to produce a CO₂-complexed CO₂-extractor. Referring to FIG. 1, for example, removing the CO₂ from the water comprises passing the CO₂ through CO₂-permeable membrane 114 from the water (e.g., in water flow chamber 108) to the CO₂-extraction solution comprising the CO₂-extractor (e.g., in CO₂-extraction solution flow chamber 112) to produce the CO₂-complexed CO₂-extractor.

According to certain embodiments, the method comprises flowing the CO₂-extraction solution comprising the CO₂-complexed CO₂-extractor from an outlet of the CO₂-extraction solution flow chamber to an inlet of a CO₂-extraction solution regeneration unit configured to release CO₂ from the CO₂-complexed CO₂-extractor and to regenerate the CO₂-extractor. As shown, for example, in FIG. 1, the method comprises flowing the CO₂-extraction solution comprising the CO₂-complexed CO₂-extractor from outlet 110b of CO₂-extraction solution flow chamber 112 to inlet 104c CO₂-extraction solution regeneration unit 120.

In certain embodiments, the method comprises releasing CO₂ from the CO₂-complexed CO₂-extractor and regenerating the CO₂-extractor in the CO₂-extraction solution regeneration unit. For example, referring to FIG. 1, the method comprises releasing CO₂ from the CO₂-complexed CO₂-extractor and regenerating the CO₂-extractor in CO₂-extraction solution regeneration unit 120.

In some embodiments, the method comprises flowing the CO₂-extraction solution comprising the CO₂-extractor and the CO₂ released from the CO₂-extractor from an outlet of the CO₂-extraction solution regeneration unit to an inlet of a flash tank configured to remove CO₂ from the CO₂-extraction solution. As shown in FIG. 1, for example, the method comprises flowing the CO₂-extraction solution comprising the CO₂-extractor and the CO₂ released from the CO₂-extractor from outlet 110c of CO₂-extraction solution regeneration unit 120 to inlet 104d of flash tank 122.

In certain embodiments, the method comprises removing CO₂ from the CO₂-extraction solution in the flash tank. For example, referring to FIG. 1, the method comprises removing CO₂ from the CO₂-extraction solution in flash tank 122.

According to certain embodiments, the method comprises flowing the CO₂-extraction solution comprising the CO₂-extractor from an outlet of the flash tank to an inlet of the CO₂-extraction solution flow chamber. As shown in FIG. 1, for example, the method comprises flowing the CO₂-extraction solution from outlet 110d of flash tank 122 to inlet 104e of CO₂-extraction solution flow chamber 112.

In some embodiments, the method comprises flowing the CO₂ removed by the flash tank from a gaseous outlet of the flash tank to a gaseous inlet of a compressor configured to compress the CO₂. For example, as shown in FIG. 1, the method comprises flowing the CO₂ removed by flash tank 122 from gaseous outlet 126a of flash tank 122 to gaseous inlet 128 of compressor 124 configured to compress the CO₂.

According to some embodiments, the method comprises compressing the CO₂ in the compressor. Referring to FIG. 1, for example, the method comprises compressing the CO₂ in compressor 124.

In accordance with certain embodiments, the method comprises flowing the compressed CO₂ from a gaseous outlet of the compressor to a CO₂-collection unit. As shown in FIG. 1, for example, the method comprises flowing the compressed CO₂ from gaseous outlet 126b of compressor 124 to a CO₂-collection unit (not shown in FIG. 1).

In some embodiments, the method comprises adjusting the pH of the water from the second pH level (e.g., less than or equal to 7 and greater than or equal to 4) to the first pH level (e.g., greater than or equal to 7 and less than or equal to 9.5). In certain embodiments, adjusting the pH of the water from the second pH level to the first pH level comprises flowing the water from an outlet of the water flow chamber to an inlet of a water regeneration unit configured to de-acidify the water. For example, as shown in FIG. 1, adjusting the pH of the water from the second pH level to the first pH level comprises flowing the water from outlet 110e of water flow chamber 108 to inlet 104f of water regeneration unit 130 configured to de-acidify the water.

In some embodiments, the method comprises flowing the water (e.g., at the first pH level) from an outlet of the water regeneration unit to a water source. For example, referring to FIG. 1, the method comprises flowing the water from outlet 110f of water regeneration unit 130 to a water source (not shown in FIG. 1).

As described herein, the CO₂-extraction solution regeneration unit may comprise an electrochemical cell. According to certain embodiments, the method comprises flowing the CO₂-extraction solution comprising the CO₂-complexed CO₂-extractor from an outlet of the CO₂-extraction unit (e.g., an outlet of the CO₂-extraction solution flow chamber) to an inlet of an anode chamber of an electrochemical cell. For example, as shown in FIG. 2, the method comprises flowing the CO₂-extraction solution comprising the CO₂-complexed CO₂-extractor from outlet 110b of CO₂-extraction solution flow chamber 112 to inlet 104g of anode chamber 134 of electrochemical cell 132.

In some embodiments, the method comprises oxidizing at least a portion of the CO₂-extraction solution in the anode chamber to release CO₂ from the CO₂-complexed CO₂-extractor. Referring to FIG. 2, for example, the method comprises oxidizing at least a portion of the CO₂-extraction solution in anode chamber 134 to release CO₂ from the CO₂-complexed CO₂-extractor. In some embodiments, oxidizing at least the portion of the CO₂-extraction solution in the anode chamber to release CO₂ from the CO₂-complexed CO₂-extractor comprises applying a potential across the electrochemical cell. Referring, for example to FIG. 2, oxidizing at least the portion of the CO₂-extraction solution in anode chamber 134 to release CO₂ from the CO₂-complexed CO₂-extractor comprises applying potential 138 across electrochemical cell 132.

In some non-limiting embodiments, the CO₂-extractor may comprise a redox active moiety (e.g., a quinone, a disulfide, and/or a bipyridine). The redox active CO₂-extractor may, in some embodiments, complex CO₂ in the CO₂-extraction unit, as described herein, in an activated (e.g., reduced) form, thereby producing the CO₂-complexed CO₂-extractor. In certain embodiments, oxidizing at least the portion of the CO₂-extraction solution in the anode chamber comprises applying the potential across the electrochemical cell to release CO₂ from the CO₂-complexed CO₂-extractor, thereby producing a deactivated (e.g., neutral) CO₂-extractor.

In accordance with certain embodiments, the method comprises flowing the CO₂-extraction solution comprising the CO₂ released from the CO₂-extractor and the deactivated CO₂-extractor from an outlet of the anode chamber to an inlet of a flash tank. For example, as shown in FIG. 2, the method comprises flowing the CO₂-extraction solution comprising the CO₂ released from the CO₂-extractor and the deactivated CO₂-extractor from outlet 110h of anode chamber 134 to inlet 104d of flash tank 122.

In some embodiments, the method comprises removing CO₂ from the CO₂-extraction solution in the flash tank. Referring to FIG. 2, for example, the method comprises removing CO₂ from the CO₂-extraction solution in flash tank 122.

In certain embodiments, the method comprises flowing the CO₂-extraction solution comprising the deactivated CO₂-extractor from an outlet of the flash tank to an inlet of the cathode chamber. As shown, for example, in FIG. 2, the method comprises flowing the CO₂-extraction solution from outlet 110d of flash tank 122 to inlet 104h of cathode chamber 136.

According to certain embodiments, the method comprises reducing at least a portion of the CO₂-extraction solution in a cathode chamber to regenerate the CO₂-extractor. For example, referring to FIG. 2, the method comprises reducing at least a portion of the CO₂-extraction solution in cathode chamber 136 to regenerate the CO₂-extractor. In some embodiments, reducing at least a portion of the CO₂-extraction solution in a cathode chamber to regenerate the CO₂-extractor comprises applying a potential across the electrochemical cell. Referring, for example, to FIG. 2, reducing at least a portion of the CO₂-extraction solution in cathode chamber 136 to regenerate the CO₂-extractor comprises applying potential 138 across electrochemical cell 132.

In certain non-limiting embodiments, the CO₂-extractor may comprise a redox active moiety (e.g., a quinone, a disulfide, and/or a bipyridine). The redox active CO₂-extractor may, in some embodiments, release CO₂ in the anode chamber, as described herein, thereby producing the deactivated (e.g., neutral) CO₂-extractor. In some embodiments, reducing at least a portion of the CO₂-extraction solution in the cathode chamber comprises applying the potential across the electrochemical cell to regenerate the CO₂-extractor, thereby producing the activated (e.g., reduced) CO₂-extractor.

In some embodiments, the method comprises flowing the CO₂-extraction solution comprising the CO₂-extractor (e.g., activated CO₂-extractor) from an outlet of the cathode chamber to an inlet of the CO₂-extraction solution flow chamber. As shown in FIG. 2, for example, the method comprises flowing the CO₂-extraction solution comprising the CO₂-extractor from outlet 104h of cathode chamber 136 to inlet 104e of CO₂-extraction solution flow chamber 112.

### Example 1

The following example describes a system for the removal of CO₂ from seawater.

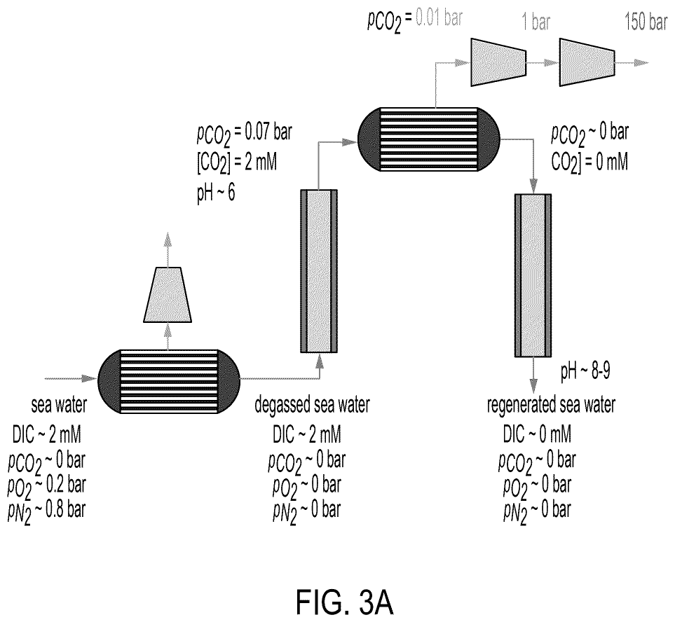

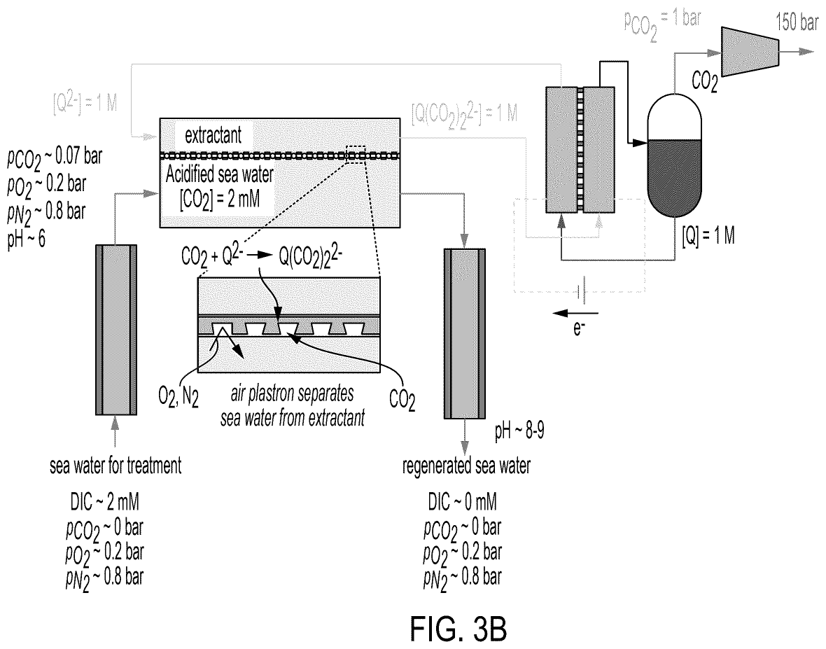

FIG. 3A shows a schematic diagram of a conventional process for removing CO₂ from seawater. As shown in FIG. 3A, seawater is degassed to remove O₂ and N₂ prior to feeding the seawater to an electrochemical cell. In addition, CO₂ is desorbed under vacuum, requiring multistage compression to raise the pressure of the pure stream from nominally 0.01 bar to 150 bar.

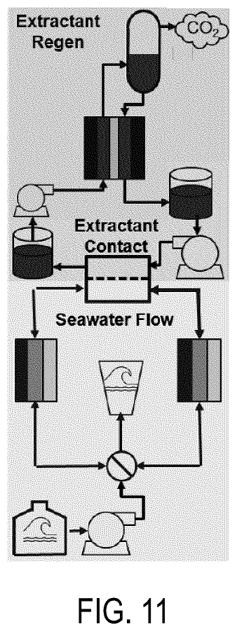

An exemplary system for the removal of CO₂ from seawater is shown in FIG. 3B. As shown in FIG. 3B, the acidified seawater is introduced to a membrane contactor where it is exposed to an electrochemically activated solvent that has a high affinity for the CO₂, and with which it complexes even under very low partial pressures. The sorbent has little to no affinity for O₂ or N₂, and thus these gases are not co-extracted with the CO₂, obviating the need for pre-degasification. The membrane separating the feed water and the extractant is selected to prevent loss of extractant to the ocean water, or contamination of the extractant by the ocean water. Once the extractant is loaded with complexed CO₂, it is introduced to the anode chamber of an electrochemical cell, where it is deactivated by oxidation and the CO₂ is removed in a flash tank. The extractant is then fed to the cathode chamber to be activated by electrochemical reduction before being sent back to the membrane contactor unit. The electrochemical cell is smaller than both the membrane contactor and the acidification/alkalization cells and considerably reduces the need for low pressure vacuum pumps and compressors, therefore significantly reducing energy demands and overall process footprint. See also FIG. 11, which shows a schematic diagram of an extractant mediated direct ocean capture (DOC) system.

In this system, the solution can be pumped to high pressures before it is fed to the regeneration cell and therefore the CO₂ can be released at high pressure. However, the physically dissolved CO₂ concentration following disengagement is larger than at lower release pressures, therefore diminishing the working capacity of the activated sorbent. This can be addressed by reducing the pressure in the flash tank, and then re-pressurizing the solution before it is sent to the cathode chamber. The additional pumping energy for re-pressurization is minimal relative to other energetic demands. An advantage of this high-pressure cell operation with reduced-pressure disengagement is that bubble formation within the electrochemical cell is suppressed, along with their many negative effects on required overpotentials, etc., to sustain high current operations.

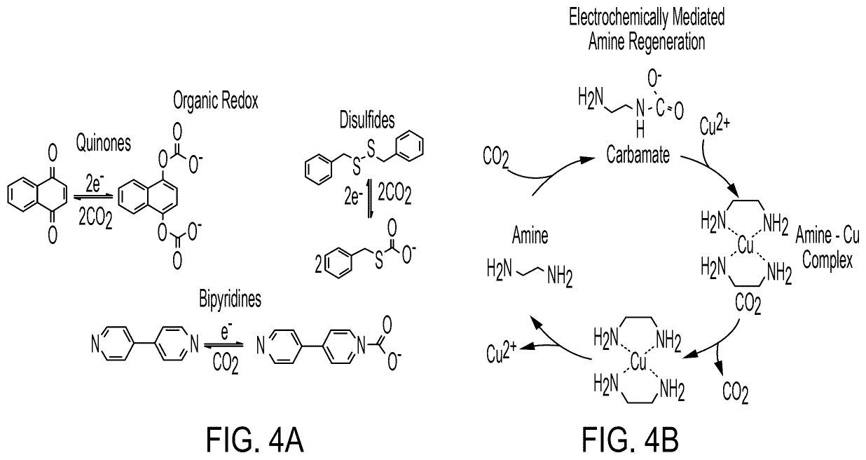

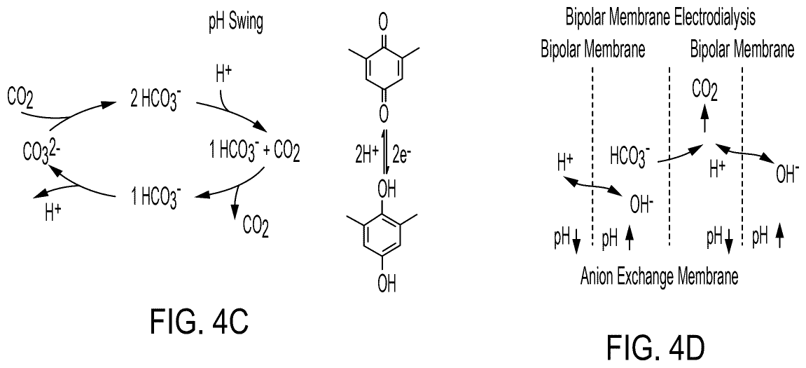

The extractant can be either an organic (aprotic) or an aqueous (protic) solution of redox active components, e.g., quinones, disulfides, bipyridines, and/or organic dyes (FIG. 4A). In aprotic media the CO₂ sorption is via direct complexation with the reduced redox molecules, while in aqueous media protonation of the reduced redox moieties leads to large increases in pH which allows extraction of the CO₂ as a carbonate and/or bicarbonate (FIG. 4C). In some approaches, this pH modulation can be through the intercalation and de-intercalation of protons from suitable electrodes and not from direct electrochemical activity of agents in solution. In this case, a swing process is utilized since one electrode will be depleted of, and the other replenished with, protons, and the flows and polarities are reversed periodically. In other approaches, amines can be used for the capture of the CO₂, which can then be regenerated by introduction of, e.g., cupric ions, which displace and liberate the CO₂, as in the EMAR process (FIG. 4B). In yet other approaches, bipolar membrane electrodialysis may be utilized for the capture of the CO₂ (FIG. 4D).

Since the fugacity of the free CO₂ in the acidified ocean water is on a par with its fugacity in conventional industrial flue gases, traditional sorbents such as amines, which have low capacity for CO₂ under ambient air conditions, can be used effectively for extraction of the CO₂ and can then be regenerated thermally.

The membrane prevents mixing of the phases and dissolution of the solvent in the feed water, while permitting the cross-over of the CO₂. The membrane has selectivity for CO₂ over other dissolved gases, and the solvent has a higher capacity for CO₂ than for other gases. An exemplary configuration is when the pores of the membrane are filled with air (see FIG. 3B), so that they offer minimal diffusional resistance to transfer across the membrane and the majority of the mass transfer resistance is on the feed water side, as it would be in any membrane desorption unit.

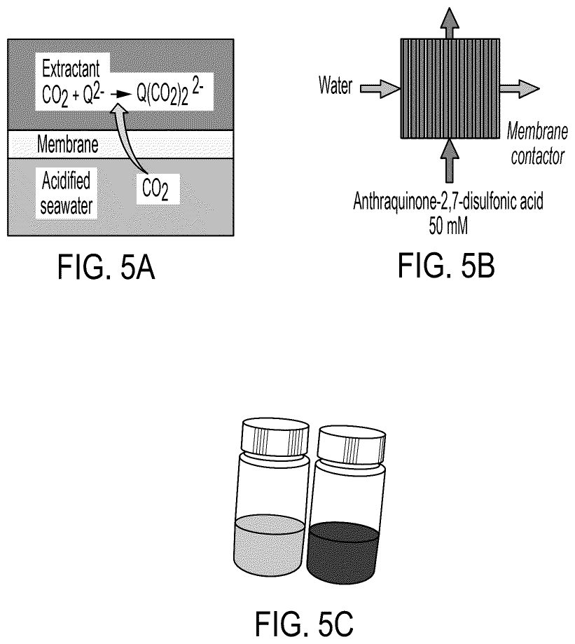

As previously described, in conventional CO₂ recovery operations, a vacuum is used to facilitate the release of CO₂ from acidified water, resulting in low CO₂ partial pressures in the final product stream that require significant compression to bring them up to desired pressures. To avoid producing CO₂ gas at these low concentrations, an exemplary system was designed for extraction of CO₂ from acidified seawater. A CO₂ absorbent was used in the system, promoting the CO₂ transfer from seawater to the absorbent. Since both the acidified water and the CO₂ absorbent are in liquid phases, the two phases were separated by a membrane that selectively passes CO₂ while blocking the transport of water or CO₂ absorbent (FIG. 5A).

For this purpose, a membrane contactor with hollow fiber membranes was selected, and a test was carried out to see if the membrane could successfully separate the two phases. As shown in FIG. 5B, deionized (DI) water and an aqueous solution of a quinone (50 mM of antraquinone-2,7-disulfonic acid) were fed to each inlet of the membrane contactor at a 1 mL/min flow rate. The photographs of the two phases after passing through the membrane contactor are shown in FIG. 5C. The DI water (left) remained transparent, while the quinone solution (right) had a dark red color. Through this experiment, it was confirmed that the membrane contactor could prevent the mixing of the two phases, and specifically, no transfer of the absorbent molecules to the water was observed.

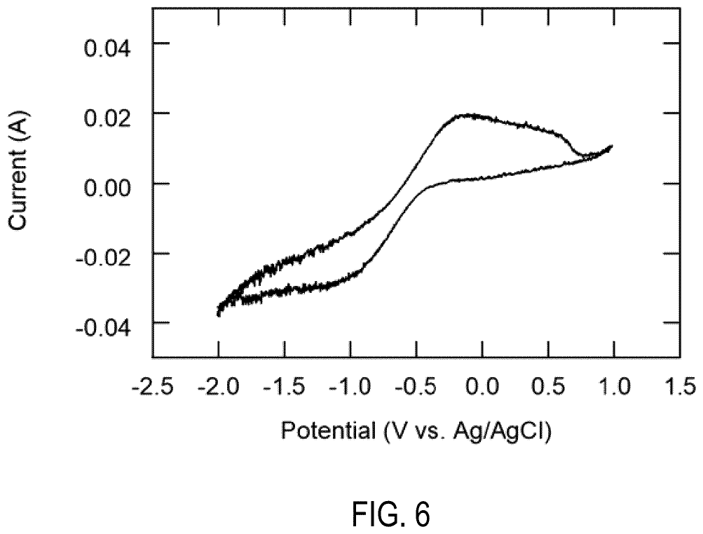

In this system, after the CO₂ absorbent extracts CO₂ from the acidified water, the CO₂ should be desorbed, and the absorbent should be regenerated, obtaining a highly concentrated CO₂ stream. Anthraquinone-2,7-disulfonic acid was selected as the CO₂ absorbent. The reduced quinone absorbs CO₂ and can desorb CO₂ by oxidizing the quinone electrochemically after the absorption is completed. Therefore, the redox reaction of quinone was investigated using cyclic voltammetry (CV). FIG. 6 shows apparent redox peaks, indicating that the quinone is successfully reduced and oxidized. An aqueous solution containing 50 mM of anthraquinone-2,7-disulfonic acid and 0.3 M of NaCl was used as the electrolyte, and graphite felt was used as a working electrode.

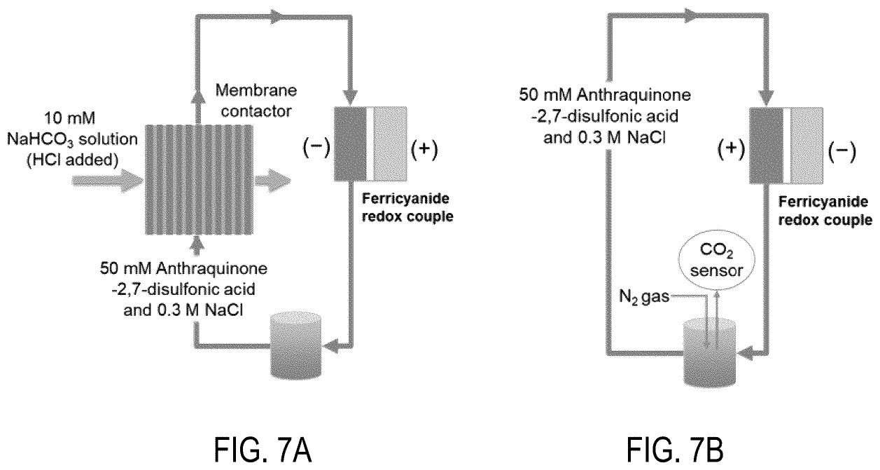

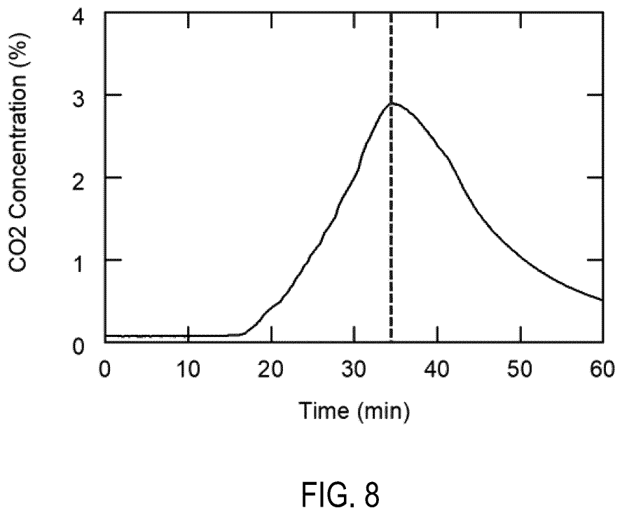

FIGS. 7A-7B show the process diagrams of the system used for the transport of CO₂ from water to the quinone solution in the membrane contactor. The system was operated in two steps. In the first step (FIG. 7A), the quinone was reduced in the electrochemical cell, and fed to the fibers within the membrane contactor, while the aqueous solution containing CO₂ was introduced to the shell side of the contactor unit. This solution was prepared by adding hydrochloric acid to a 10 mM aqueous NaHCO₃ solution. In the electrochemical cell, the ferricyanide redox couple reacted at the counter electrode. After 30 minutes, the system switched to the second step (FIG. 7B), in which the quinone was oxidized and the CO₂ released. To verify that CO₂ did transfer from the water phase to the quinone solution, the quinone reservoir was purged with nitrogen, and the CO₂ concentration in the outlet was measured using a CO₂ sensor. As shown in FIG. 8, the CO₂ concentration increased when the oxidative current was applied (left of the dotted line). From this result, it was confirmed that the CO₂ contained in the water stream was transferred to the quinone solution through the membrane contactor, and the transferred CO₂ could be desorbed through the electrochemical oxidation of the quinone.

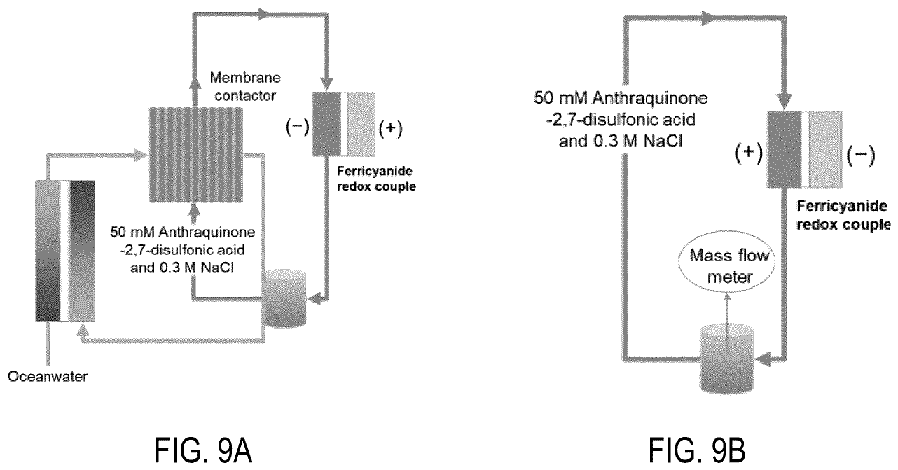

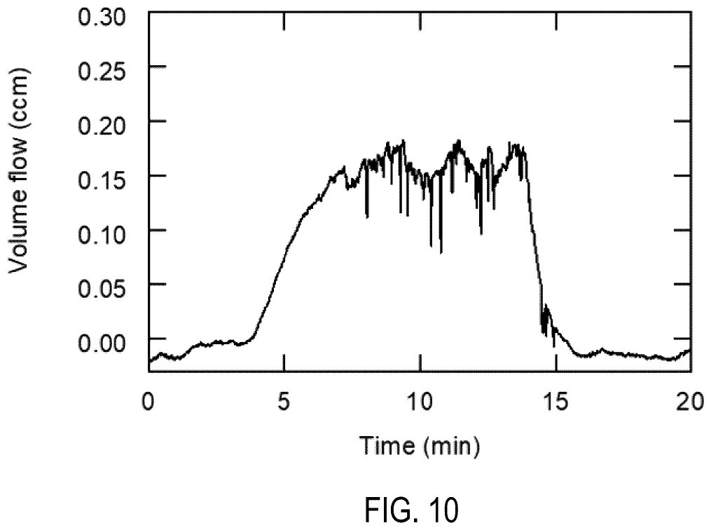

The electrochemical CO₂ removal from simulated oceanwater combined with the quinone-based CO₂ extraction was also demonstrated. FIGS. 9A-9B show the process diagrams of this system. In the first step (FIG. 9A), the acidified oceanwater from a Bi/BiOCl system was pumped to the membrane contactor, and CO₂ was transferred to the quinone solution that was reduced in the other electrochemical cell. Then, the CO₂-depleted oceanwater entered the other compartment of the Bi/BiOCl cell to be re-alkalized. After completing this step, the system switched to the second step (FIG. 9B), in which the quinone solution was oxidized in the electrochemical cell, and the CO₂ released. A nitrogen sweep stream was not used with measurement of the CO₂ concentration, but the amount of gas released from the system was followed with a mass flow meter. As shown in FIG. 10, the gas flow rate increased when the oxidative current was applied, indicating that CO₂ was released at high concentration without the use of a sweep gas or a vacuum pump.

### Example 2

The following example describes the percentage of CO₂ recovered from water using conventional degassing systems.

In the limit of infinite membrane contactor area with a fixed driving force, the phase speciation resulting from degassing seawater or removing CO₂ with vacuum can be determined with a standard flash calculation, subject to the following assumptions: (i) gas and liquid streams leaving the flash tank are in equilibrium with each other; (ii) the flash tank operates at isothermal conditions-all streams enter and leave at the specified temperature; (iii) complete separation of vapor and liquid phases is achieved-no liquid is entrained in the effluent vapor phase; and (iv) vapor solubilities are assumed to be governed by Henry's law, and binary interactions are neglected.

All modeled components “i” are considered volatile (i∈{H₂O, CO₂, O₂, N₂}). For ease of notation, the subset of gas-only species are denoted with a subscript j (j∈{CO₂, O₂, N₂}). Denoting molar flow rates of feed, vapor effluent, and liquid effluent as Fₘ, Vₘ, and Lₘ, respectively, and respective liquid and vapor fractions of species as xᵢ and yᵢ, respectively, the following mass balances and Dalton's law relations can be determined:

$${F}_{m} {x}_{F , i} = {L}_{m} {x}_{L , i} + {V}_{{m}^{x} V , i} \qquad ( 1 )$$

$${P}_{j} = {P}_{V} {y}_{j} \qquad ( 2 )$$

$${P}_{H 2 O} = {P}_{Sat , H 2 O} ( {T}_{Flash} ) \qquad ( 3 )$$

Solubility of gas phase species (CO₂, O₂, and N₂) in water is determined using Henry's constant. Data provided by the Engineering Equation Solver (EES) thermodynamic package define Henry's constant relation with the following convention:

$${x}_{j} = \frac{{P}_{j}}{{H}_{j} ( {T}_{Flash} )} \qquad ( 4 )$$

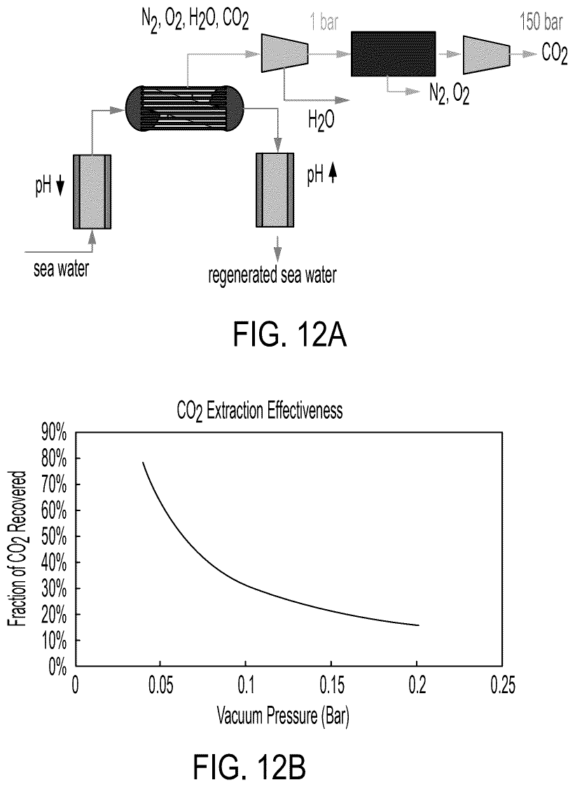

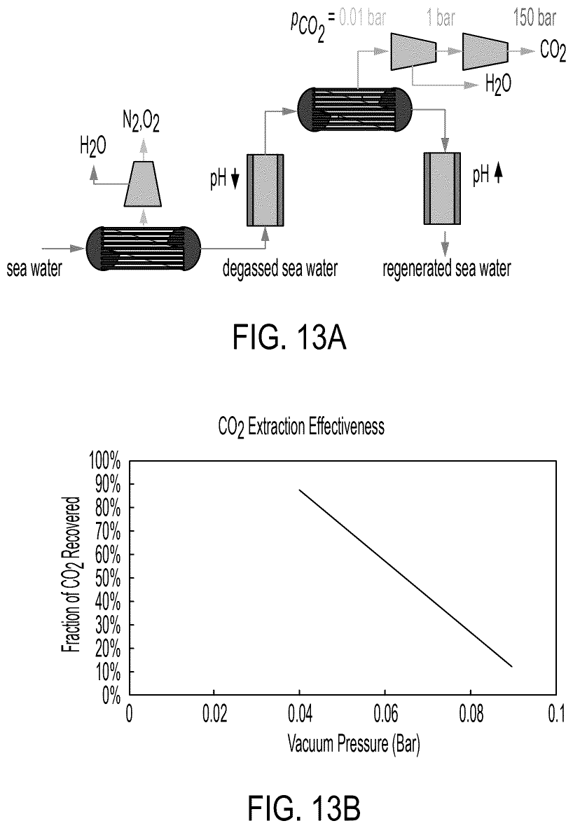

Using the above equations, the effectiveness values (i.e., percentage of CO₂ recovered from the seawater stream) for single (see FIGS. 12A-12B) and double stage degassing systems (see FIGS. 3A-13B) can be determined.

The data indicates that, in conventional systems, the strength of the vacuum used to remove CO₂ from water is proportional to the CO₂ removal efficiency but requires more compression work downstream to raise the CO₂ pressure such that the CO₂ is suitable for industry applications. The conventional systems therefore result in an overall greater energy penalty as compared to the systems described herein, which: (i) do not use a vacuum to remove CO₂ from water; and (ii) utilize less compression downstream, as the removed CO₂ has a greater pressure than the CO₂ removed in conventional systems.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements): etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one. A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for removing carbon dioxide (CO₂) from water, comprising:
a water treatment unit configured to adjust pH of the water comprising one or more carbon-containing species from a first pH level to a second pH level that is lower than the first pH level to convert at least some of the one or more carbon-containing species to CO₂;
a CO₂-extraction unit comprising a CO₂-permeable membrane, wherein the CO₂-extraction unit is configured to comprise a CO₂-extraction solution, and wherein the CO₂-extraction unit is configured to remove the CO₂ from the water across the CO₂-permeable membrane into the CO₂-extraction solution; and
a water regeneration unit configured to adjust the pH of the water from the second pH level to the first pH level.

2. The system of claim 1, wherein the system does not comprise a degasification unit and/or a vacuum configured to remove one or more dissolved gases from the water.

3. The system of claim 1, wherein the CO₂-extraction unit comprises a water flow chamber and a CO₂-extraction solution flow chamber separated by the CO₂-permeable membrane.

4. The system of claim 3, wherein the water flow chamber is configured to flow the water comprising the CO₂ in contact with a first surface of the CO₂-permeable membrane and the CO₂-extraction solution flow chamber is configured to flow the CO₂-extraction solution comprising a CO₂-extractor in contact with a second surface of the CO₂-permeable membrane such that the CO₂ passes through the CO₂-permeable membrane from the water into the CO₂-extraction solution to produce a CO₂-complexed CO₂-extractor.

5. The system of claim 4, wherein the first surface of the CO₂-permeable membrane is substantially opposite the second surface of the CO₂-permeable membrane.

6. The system of claim 1, wherein the CO₂-permeable membrane comprises a hollow-fiber membrane.

7. The system of claim 1, wherein the CO₂-permeable membrane comprises polypropylene and/or polytetrafluoroethylene.

8. The system of claim 4, further comprising a CO₂-extraction solution regeneration unit configured to release the CO₂ from the CO₂-complexed CO₂-extractor and to regenerate the CO₂-extractor.

9. The system of claim 8, wherein an outlet of the CO₂-extraction solution flow chamber is fluidically connected to an inlet of the CO₂-extraction solution regeneration unit.

10. The system of claim 8, wherein the CO₂-extraction solution regeneration unit is an electrochemical cell.

11. The system of claim 8, further comprising a flash tank configured to remove the CO₂ released from the CO₂-extractor.

12. The system of claim 11, wherein an outlet of the CO₂-extraction solution regeneration unit is fluidically connected to an inlet of the flash tank, and wherein an outlet of the flash tank is fluidically connected to an inlet of the CO₂-extraction solution flow chamber.

13. The system of claim 11, further comprising a compressor configured to compress the CO₂ removed by the flash tank.

14. The system of claim 13, wherein a gaseous outlet of the flash tank is fluidically connected to a gaseous inlet of the compressor.

15. The system of claim 1, wherein the CO₂-extraction solution comprises an organic, aprotic solvent.

16. The system of claim 1, wherein the CO₂-extraction solution comprises an aqueous, protic solvent.

17. The system of claim 4, wherein the CO₂-extractor comprises a redox active moiety.

18. The system of claim 17, wherein the CO₂-extractor comprises a quinone, a disulfide, and/or a bipyridine.

19. The system of claim 4, wherein the CO₂-extractor comprises an amine.

20. The system of claim 4, wherein the CO₂-extractor comprises a carbonate (CO₃²⁻).

21. The system of claim 1, wherein the water is seawater.

22-45. (canceled)

46. A method for removing CO₂ from water, comprising:
adjusting pH of the water comprising one or more carbon-containing species from a first pH level to a second pH level that is lower than the first pH level to convert at least some of the one or more carbon-containing species to the CO₂;
exposing the water comprising the CO₂ to a CO₂-extraction unit comprising a CO₂-permeable membrane;
exposing a CO₂-extraction solution to the CO₂-extraction unit;
removing the CO₂ from the water across the CO₂-permeable membrane into the CO₂-extraction solution; and
adjusting the pH of the water from the second pH level to the first pH level.

47-72. (canceled)
